(19) United States
(12) Patent Application Publication
(10) Pub. No.: US 2007/0058766 A1
(43) Pub. Date: Mar. 15, 2007

(54) Methods and apparatus for recovering serial data

(75) Inventors: Timothy S. Falls, Batavia, IL (US); Sean M. Furuness, Naperville, IL (US); Lawrence D. Weizeorick, Lisle, IL (US)

Correspondence Address: Dean D. Small;Armstrong Teasdale LLP, Suite 2600, One Metropolitan Square, St. Louis, MO, 63102, US

(73) Assignee: Tellabs Operations, Inc.

(21) Appl. No.: 11/226,021

(22) Filed: Sep. 14, 2005

(51) Int. Cl. H04L 7/00

(52) U.S. Cl. 375/371; 375/372

(57) ABSTRACT

A phase alignment device for alignment of phase between a data signal and a clock signal is described. The phase alignment device includes a signal generator generating an enable signal configured to control shifting of the data signal through an external data buffering device, a reference signal module generating phase reference signals based on the clock signal, the phase reference signals differing in phase from one another, and a data sampler identifying a reference point in the data signal. The phase alignment device further includes a phase capture module identifying one of the phase reference signals closest in phase to the reference point in the data signal as a selected phase reference signal.

### BACKGROUND OF THE INVENTION

This invention relates generally to the transmitting and receiving of serial data, and more specifically, to methods and apparatus for recovering serial data received from an external circuit.

Whenever serial data is transmitted from one module to another, for example, from one circuit to another, it is typically transmitted without an accompanying clock transmission for data synchronization. In such a scenario, a substitute clock signal is generated at the receiving module in order to clock in the serial data to the module. If the rate of the serial data is at a known frequency, for example, as is the case with a synchronous data format, then a clock that is approximately the same frequency as the serial data can be provided through another source. With one clock being generated at the “sending” module, and another clock being generated at the “receiving” module, it is typical that these clocks are not exactly the same frequency, resulting in a shifting, or non-stable, phase relationship between the transmitted data, and the clock being utilized to clock in such data. The clock at the receiving module, along with a phase aligner, are utilized to recover the data in the absence of a fixed data/clock phase relationship.

At least one known phase aligner requires four phased clock inputs. The four clock inputs are separated from each other by a quarter of a clock cycle. For reference purposes, the first clock is considered to be at a 0° phase shift, the second clock is considered to be at a 90° phase shift, the third clock is considered to be at a 180° phase shift, and the fourth clock is considered to be at a 270° phase shift. Extra care is taken during the design phase as well as for the placement and routing of signals for these phase aligners so that the phase relationship, rising/falling edge, and clock duty cycle timing of the clock signals is tightly controlled. If these parameters are not tightly controlled, the phase aligner may not be able to correctly track the data through the various phases, especially if the duty cycle of the data is not optimal. Also, since timing of these clock inputs may be subjected to variations in operational temperature and voltage conditions, as well as process variations in the manufacturing of the die on which these circuits are formed, the performance of such phase aligners may become degraded.

The above described phase aligners are typically utilized along with a small FIFO buffer (e.g., an eight bit buffer), a phase detector, and a phase locked loop (PLL) to provide a type of data recovery and to match the PLL clock to the data rate. Various clock and data recovery (CDR) circuits are used extensively in the industry, especially in high-speed SONET applications. A CDR circuit could be used, instead, to recover both the data stream and the clock signal. However, CDR circuits are much larger, more complex, and more expensive than the above described phase aligner approach.

CDR circuits are able to provide low jitter data recovery for high bandwidth data, however, in applications where high speed and jitter is not an issue, utilizing a phase aligner is the preferred solution.

### BRIEF DESCRIPTION OF THE INVENTION

A phase alignment device for alignment of phase between a data signal and a clock signal is provided. The phase alignment device comprises a signal generator generating an enable signal, based on the selected phase reference signal, configured to control shifting of the data signal through an external data buffering device, a reference signal module generating phase reference signals based on the clock signal, the phase reference signals differing in phase from one another, and a data sampler identifying a reference point in the data signal. The phase alignment device further comprises a phase capture module identifying one of the phase reference signals closest in phase to the reference point in the data signal as a selected phase reference signal.

A method for recovering serial data from a signal in the absence of a fixed data and clock phase relationship is also provided. The method comprises generating phase reference signals based on a clock signal, the phase reference signals differing in phase from one another, identifying a reference point in a data signal, and identifying one of the phase reference signals closest in phase to the reference point in the data signal as a selected phase reference signal. The method also comprises generating an enable signal based on the selected phase reference signal, and using the enable signal to control shifting of the data signal through an external data buffering device.

A phase alignment device for alignment of phase between a data input signal and an externally generated clock signal, where the clock signal has a frequency that is higher than a frequency of the data signal is also provided. The phase alignment device comprises a data sampler comprising a circuit that identifies a reference point in the data input signal and shifts the data input signal to an aligned data output of the phase alignment device based on the clock signal, and a reference signal module generating phase reference signals based on the clock signal, the phase reference signals differing in phase from one another. The phase alignment device further comprises a phase capture module comprising logic that identifies the phase reference signal closest in phase to the identified reference point in the data input signal, a signal generator outputting an enable signal to an external device, the enable signal causing the external device to receive as an input the aligned data output of the phase alignment device.

### BRIEF DESCRIPTION OF THE DRAWINGS

FIG. 1 is a block diagram of a circuit that incorporates a phase aligner.

FIG. 2 is a block diagram of one embodiment of the phase aligner of FIG. 1.

FIG. 3 is a timing diagram associated with the embodiment of tri-phase aligner illustrated in FIG. 2.

### DETAILED DESCRIPTION OF THE INVENTION

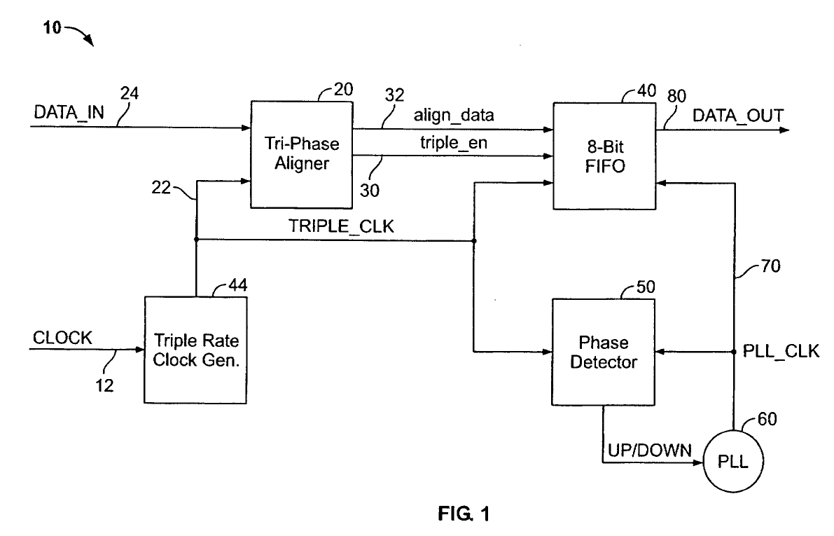

FIG. 1 is a block diagram of a circuit 10 that incorporates a tri-phase aligner 20 according to the present invention. The tri-phase aligner 20, as is described herein, is more robust than known phase aligners. Since the tri-phase aligner 20 is configured to utilize a triple rate clock signal 22 to generate three phases instead of four as in one known phase aligner, it is more difficult for data 24 being input to the tri-phase aligner 20 to jump across multiple phase boundaries. In addition, since the tri-phase aligner 20 tracks the input data 24 using rising-edge detection, the tri-phase aligner 20 will re-align one of the clock phases every time the data 24 transitions from low to high. To contrast, at least one known phase aligner utilizes single bit-wide data pulses and cannot re-align if the data input to the aligner does not contain single bits. In an alternative embodiment, the tri-phase aligner 20 tracks the input data 24 using falling-edge detection.

The tri-phase aligner 20 aligns the input data 24 using a triple-rate clock signal 22, which as the name implies, is a clock signal that is substantially three times the frequency of the input data 24. The clock signal 22 is three times the frequency of the input clock 12, which results in multiple opportunities to align the data with the clock 12 in phase. Within the tri-phase aligner 20, the input data 24 is sampled using the triple-rate clock signal 22, and then an edge detection circuit (not shown in FIG. 1) is utilized to determine when there is a rising edge of the data. An appropriate one of the three generated phases of the triple-rate clock 22 is selected whenever a rising edge of the input data 24 occurs. The selected phase is then utilized as an enable signal 30 to write the data (e.g., aligned data signal 32) into the next processing stage, typically a FIFO buffer 40. Though described herein as selecting one of the three generated phases of the triple-rate clock 22 whenever a rising edge of the input data 24 occurs, it is to be understood that embodiments that utilize falling edge detection are also contemplated.

In one embodiment, the tri-phase aligner 20 selects the phase that occurs 120° after the rising edge of the input data 24. However, whenever the input data 24 is transitioning across one of the boundaries of the three phases generated within the tri-phase aligner 20, the tri-phase aligner 20 is configured to select a new phase (one of the other two phases. In one embodiment, for one data bit cycle, the selected phase is either the 0° or the 240° phase. In the embodiment, the 0° or the 240° phase is selected because the change in the rising edge of the samples of the input data 24 takes place before the new phase is selected. Once a new phase has been selected, it will remain in effect until the next rising edge of the input data 24.

The block diagram of FIG. 1 illustrates a typical utilization for the tri-phase aligner, including the eight bit FIFO 40, a triple rate clock generator 44, a phase detector 50, and a phase locked loop 60. The above listed components, together align an input data stream 24 and synchronize the input data stream 24 to the system PLL clock 70 by outputting an output data stream 80.

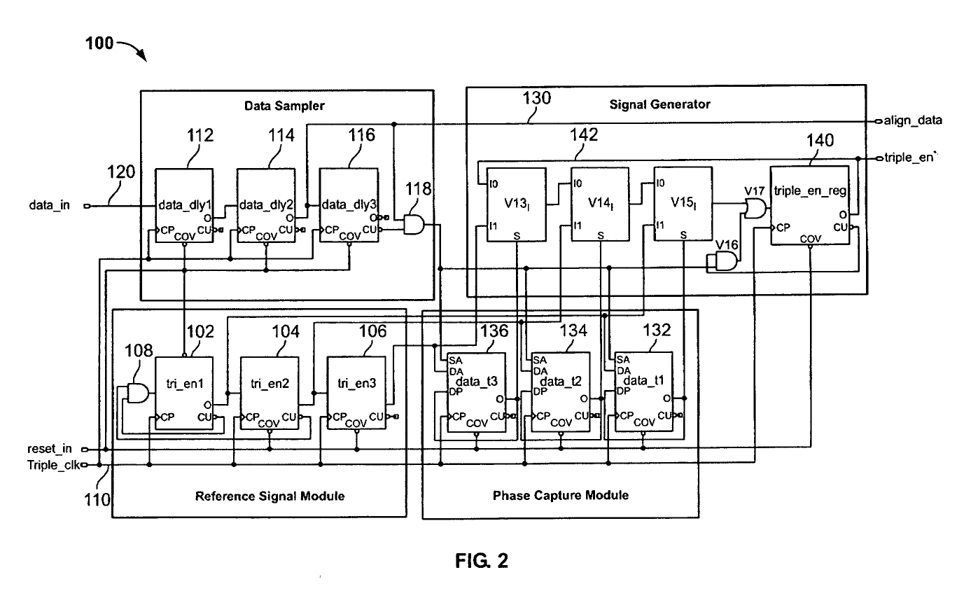

FIG. 2 is a detailed block diagram of one embodiment of a tri-phase aligner 100. The tri-phase aligner 100 includes three phase reference flip-flops, 102, 104, and 106 respectively, that are configured to provide three separate phase reference signals within the tri-phase aligner 100. These phase reference signals are generated by shifting a pulse in a circular manner from flip-flop 102, to flip-flop 104, and then to flip-flop 106, after which another pulse is generated again for flip-flop 102. The reference signals circulate through flip-flops 102, 104, and 106 continuously. The phase reference signals generated by the flip-flops 102, 104, and 106 are used by the tri-phase aligner 100 to delineate three adjacent cycles of triple rate clock 110. Together, flip-flops 102, 104, and 106 along with AND gate 108 form a reference signal module generating phase reference signals based on the clock signal of clock 110, the phase reference signals differing in phase from one another.

The tri-phase aligner 100 further includes data delay flip-flops 112, 114, and 116 which, along with AND gate 118, are configured to resynchronize data in signal 120 to the triple rate clock 110. Resynchronized data signal 130 is then passed on as an aligned data output, to be received by FIFO 40 (shown in FIG. 1). Data delay flip-flops 112, 114, and 116 are also configured to detect a rising edge of the data in signal 120. Flip-flops 112, 114, and 116 and gate 118 form a data sampler that identifies a reference point in the data in signal 120, for example, the rising edge. More specifically, whenever a rising edge occurs in the data in signal 120, a state of each of the three phases is shifted into data storage flip-flops 132, 134, and 136 for storage. As such, flip-flops 132, 134, and 136 provide data indicative of which of the three phases is active at the time of a rising edge at data input 120. Flip-flops 132, 134, and 136 form a phase capture module that identifies one of the phase reference signals that is closest in phase to the reference point (rising edge) in the data signal as a selected phase reference signal. The logic components in FIG. 2 identified as U13, U14, U15, U16, and U17, along with flip-flop 140 provide a signal generator module. Logic components U13, U14, and U15 shift the phase of an enable signal input into triple enable register flip-flop 140 to be in phase with the selected phase reference signal.

The triple enable register flip-flop 140 generates a triple enable output 142 which is used by the aligner FIFO 40 to enable when the aligned data output signal 130 is to be clocked into the FIFO 40, based on the triple rate clock 110. In one embodiment, the tri-phase aligner 100 generally centers the triple enable output 142 in the middle phase (e.g., 120 degrees) of the aligned data output 130, however, when the data transitions from being in phase with one phase of the triple rate clock 110 to being in phase with an earlier or later phase of the clock 110, then the tri-phase aligner 100 will select either of an earlier or later phase so that the triple enable output 142 is resynchronized with the aligned data output 130. Further, when the data transitions from one phase to the next earlier phase, such as from phase three to phase two (e.g., 240 degrees to 120 degrees), then an extra pulse is generated by triple enable register flip-flop 140, along with gates U16 and U17, to ensure that all the data bits are clocked into the FIFO 40 during this transition. Without the extra pulse, one data bit would be lost, since the choice to transition to the new phase is made the next clock cycle after the new phase enable has occurred.

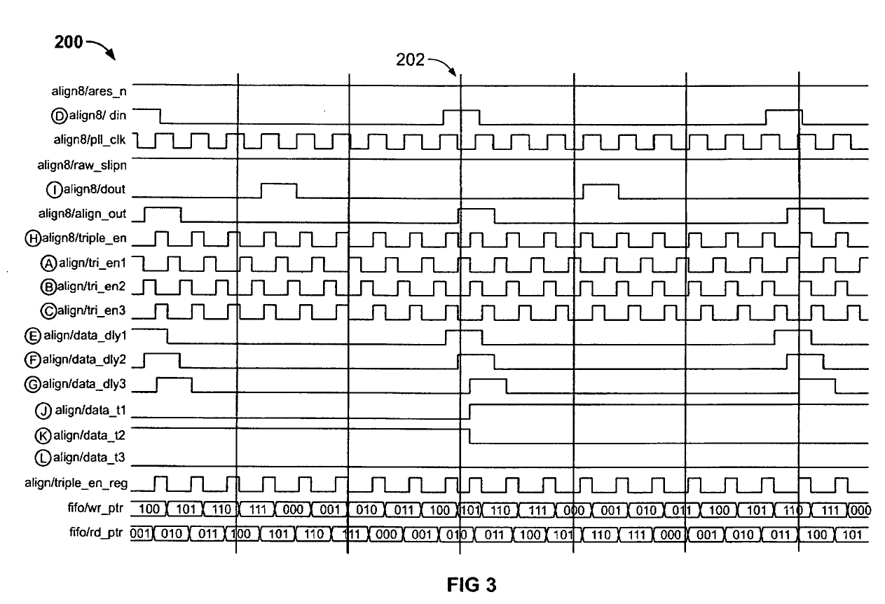

FIG. 3 is a timing diagram 200 that is associated with the phase aligner circuit 100 illustrated in FIG. 2. Though the triple rate clock signal is not illustrated, phase reference signals A, B, and C are generated by the reference signal module (flip-flops 102, 104, and 106) described above. As can be discerned from FIG. 3, the phase reference signals are substantially 120 degrees out of phase with one another. Signal D is an example of a data signal that is being input to phase aligner 100. Signals E, F, and G illustrate delay of the data in signal D based on the sampling that is resultant of the phase reference signals generated by flip-flops 102, 104, and 106.

Signal H is the enable signal output by flip-flip 140 (shown in FIG. 2) which allows for the shifting of the aligned data output signal (I) to be shifted into the FIFO buffer 40 (shown in FIG. 1). Prior to the beginning of the timing diagram 200, the data input was aligned in phase with phase 2, based upon a state of signals B and F. At timing mark 202, the tri-phase aligner 100 determines that signal A is better aligned in phase with signal D than is signal B. At this point the tri-phase aligner 100 shifts the state of the comparator module (flip-flops 132, 134, and 136) so that the enabling of flip-flop 140 is based on the state of A and E (phase 1). Signals J, K, and L are illustrative of the outputs of flip-flops 132, 134, and 136. As tri-phase aligner 100 “shifts” from phase 2 to phase 1, an extra pulse is generated at signal H to ensure that the last data bit is shifted out of tri-phase aligner 100 before the next data arrives for alignment with phase 1.

Tri-phase aligner 100 is much simpler than at least some previous phase aligner designs and the size of tri-phase aligner 100 is about a third of the size of these known previous designs. Tri-phase aligner 100 further does not require the same type of tight control that the four phase clock based phase aligners require. Specifically, the triple rate clock 110 does not require that its propagation delay, or its rising/falling edge, matches the timing of another clock, as some phase aligners do. Also, tri-phase aligner 100 is synchronous and does not use internally generated clocks. Therefore, aligner 100 can be synthesized, placed, and routed along with the other circuitry within an AS1C or FPGA design, or fabricated with discrete logic, without any special considerations. Previous phase aligner designs required that the aligner be synthesized, placed, and routed as a separate logic block so as to tightly control the timing of the phase clocks.

While the embodiments described herein refer specifically to a tri-phase arrangement with a triple rate clock, other embodiments are contemplated to be within the scope of the disclosure. Specifically, the rate of the clock may be increased to a different multiple of the data rate, for example, five times the data rate, and an aligner circuit supporting such a clock rate would incorporate analogous circuitry, for example, five phase enable flip-flops, five data delay flip-flops, and five data storage flip-flops along with similarly configured logic as illustrated in FIG. 2 to provide an enable output based on the selected phase of the input clock signal.

While the invention has been described in terms of various specific embodiments, those skilled in the art will recognize that the invention can be practiced with modification within the spirit and scope of the claims.

What is claimed is:

1. A phase alignment device for alignment of phase between a data signal and a clock signal, the phase alignment device comprising:
a signal generator generating an enable signal configured to control shifting of the data signal through an external data buffering device;
a reference signal module generating phase reference signals based on the clock signal, the phase reference signals differing in phase from one another;
a data sampler identifying a reference point in the data signal; and
a phase capture module identifying one of the phase reference signals closest in phase to the reference point in the data signal as a selected phase reference signal.

2. The device of claim 1, wherein a frequency of the enable signal is N times greater than a frequency of the data signal, the reference signal module generating N phase reference signals.

3. The device of claim 1, wherein the data sampler identifies either a rising edge or a falling edge of the data signal as the reference signal.

4. The device of claim 1, wherein the phase reference signals separated in phase by substantially equal phase shifts.

5. The device of claim 1, wherein said phase capture module is further configured to:
determine when the data signal is going to transition from being in phase with one of the phase reference signals; and
output a signal to said signal generator module enabling selection of one of the other phase reference signals for at least one data cycle.

6. A phase alignment device according to claim 1 wherein said signal generator module is configured to enable one of the phase reference signals based upon detection of either a rising edge or a falling edge of the data signal.

7. A phase alignment device according to claim 1 wherein said reference signal module comprises a plurality of flip-flops configured to generate the phase reference signals.

8. A phase alignment device according to claim 1 wherein said reference signal module comprises a plurality of flip-flops configured to delineate adjacent cycles of the clock signal.

9. A phase alignment device according to claim 1 wherein said signal generator module comprises logic configured to resynchronize the data signal with an output enable signal.

10. A phase alignment device according to claim 1 where upon the detection of one of a rising edge or a falling edge in the data signal, a state of each phase signal is shifted into said phase capture module.

11. A phase alignment device according to claim 1 wherein said a signal generator comprises a flip-flop whose output is determined based on detection of one of a rising edge or a falling edge of the data, the state of said phase reference signals, and the current state of the flip-flop.

12. A phase alignment device according to claim 1 wherein said device comprises at least one of an AS1C, a FPGA, or discrete logic.

13. The device of claim 1, wherein said phase capture module shifts a phase of the enable signal to be in phase with the selected phase reference signal.

14. A method for recovering serial data from a signal in the absence of a fixed data and clock phase relationship, said method comprising:
generating phase reference signals based on a clock signal, the phase reference signals differing in phase from one another;
identifying a reference point in a data signal;
identifying one of the phase reference signals closest in phase to the reference point in the data signal as a selected phase reference signal;
generating an enable signal based on the selected phase reference signal; and
using the enable signal to control shifting of the data signal through an external data buffering device.

15. A method according to claim 14 further comprising:
determining when the phase of enable signal is going to transition from being in phase with one of the phase signals to being in phase with another of the phase signals; and
selecting one of the other phase reference signals for at least one data bit cycle.

16. A method according to claim 14 wherein generating phase reference signals based on a clock signal comprises generating a phase enable signal for each desired phase of the clock signal.

17. A method according to claim 14 wherein generating phase reference signals based on a clock signal comprises delineating adjacent phase reference signals based on the clock signal.

18. A method according to claim 14 wherein identifying one of the phase reference signals closest in phase to the reference point in the data signal as a selected phase reference signal comprises selecting the phase reference signal that is after detection of one of a rising edge or a falling edge of the data signal.

19. A method according to claim 14 wherein an enable signal is generated based on the selected phase reference signal.

20. A method according to claim 14 where upon the identification of a reference point in a data signal, a state of each phase reference signal is stored.

21. A phase alignment device for alignment of phase between a data input signal and an externally generated clock signal, the clock signal having a frequency that is higher than a frequency of the data signal, said phase alignment device comprising:
a data sampler comprising a circuit that identifies a reference point in the data input signal and shifts the data input signal to an aligned data output of the phase alignment device based on the clock signal;
a reference signal module generating phase reference signals based on the clock signal, the phase reference signals differing in phase from one another;
a phase capture module comprising logic that identifies the phase reference signal closest in phase to the identified reference point in the data input signal; and
a signal generator module generating an enable signal based on the selected phase reference signal and outputting the enable signal to an external device, the enable signal causing the external device to receive as an input the aligned data output of the phase alignment device.
